(19) United States
(12) Patent Application Publication
(10) Pub. No.: US 2005/0247131 A1
(43) Pub. Date: Nov. 10, 2005

(54) Device and method for determining the state of a particle filter

(76) Inventor: Norbert Breuer, Ditzingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/526,307

(22) PCT Filed: Jun. 11, 2003
(86) PCT No.: PCT/DE03/01934

§ 371 Date: Mar. 2, 2005

(30) Foreign Application Priority Data
Sep. 12, 2002 (DE) 102 42 300.8

(51) Int. Cl. G01N 29/16

(52) U.S. Cl. 73/579; 73/602; 73/589

(57) ABSTRACT

A device for determining the state, in particular the permeability, of a particle filter has an acoustic source for transmitting an acoustic signal toward the particle filter and has an acoustic receiver for receiving the acoustic signal that has been changed by the particle filter. In addition, a control and evaluation unit is provided for controlling the acoustic source and evaluating the received acoustic signal.

The present invention relates to a device for determining the state of a particle filter with the characteristics mentioned in the preamble to claim 1 and a method for determining the state of a particle filter with the characteristics mentioned in the preamble to claim 9.

### PRIOR ART

Particularly in diesel engines, it is difficult to manage the interrelationship among the production of nitrogen oxides, the production of particles, and the consumption of fuel because measures taken for nitrogen oxide reduction result in increased particulate emissions and fuel consumption. Since particulate emissions cannot be entirely eliminated, suitable measures must be taken.

Particle filters (DPF) in motor vehicles (KFZ) make an important contribution to compliance with stricter exhaust limit values. These filters are highly efficient at removing particles from the exhaust flow.

Particles and diesel particles in particular are partially made up of agglomerations of primary particles composed of hydrocarbon compounds. They are also partly composed of pure carbon. They result from incomplete combustion in the combustion chamber and range from 50 to 200 nm in size. They are usually geometrically irregular in shape. The particle quantity and composition depend heavily on engine load conditions, the injection system, and the chemical composition of the fuel.

Deposited solids reduce the permeability of the filter, as a result of which the exhaust backpressure increases, which in turn leads to engine output losses and to increased fuel consumption. For this reason, the filter is regenerated after it reaches a certain saturation level. In this connection, a temperature increase serves to convert the majority of the oxidizable particulate load into gaseous carbon dioxide CO2 and carbon monoxide CO and consequently removes it from the filter. After successful regeneration, the exhaust backpressure once again assumes a significantly lower initial value.

The mass of separated particles in the filter cannot be determined directly in the motor vehicle itself. Instead, alternative methods have been developed to determine the optimum time to initiate regeneration measures.

One known method is to use a differential pressure sensor, which detects the pressure decrease via the filter body. The differential pressure and therefore the pressure decrease, however, are determined by both the filter permeability and the volumetric flow at the filter. The volumetric flow in turn depends on the operating conditions of the engine and the exhaust temperature at the filter body, thus resulting in a large degree of cross sensitivity to various influence parameters. With the usual use of ceramic wall flow filters with parallel channels, the flow resistance is the result of the parallel connection of all of the filter channels and the surface elements contained in them. If a sufficiently large number of these surface elements is cleaned by the regeneration, then the flow resistance decreases so far that a control unit, which monitors the regeneration, could erroneously conclude that the regeneration is complete, and therefore terminate the temperature-increase measures and thus the particulate oxidation. This can result in undesirable accumulations of combustible material in some regions of the DPF.

Another possibility for determining the load state of the DPF is to use characteristic field data to calculate the particulate mass emitted by the motor through chronological integration over the operating points through which the engine has passed. This method has a large degree of uncertainty, particularly in dynamic driving conditions, due to the risk of an error-induced change in particulate emissions. It can be taken into account for plausibility testing of other measurement methods.

In order to avoid this uncertainty in the calculated particulate emission, another possibility is to measure the particulate concentration upstream of the DPF with the aid of a sensor.

Due to considerable technical difficulties in several areas, none of these basic concepts has yet reached market maturity.

As mentioned above, the sensor is only an aid for estimating the fill state of the DPF through integration of the particulate quantity produced by the motor. The regeneration method itself introduces an uncertainty into the determination of the fill state. Since the increase in temperature represents a significant intervention into the motor management, this measure should be executed as seldom as possible and for as short a time as possible. As a result of this, in actual use, the problem of the DPF not being completely regenerated can arise and regions of the filter can remain partially loaded with residue. If additional particulate matter continues to accumulate during the subsequent loading phase, then a critical load concentration can occur in certain areas, which leads to an overheating in these areas in subsequent regeneration cycles. This can result in irreversible damage to filter structures.

### ADVANTAGES OF THE INVENTION

The device and method according to the present invention have the advantage that even during the regeneration phase, it is possible to reliably determine the state of the particle filter and therefore, in addition to the fill state and permeability, its degree of regeneration as well.

The device according to the present invention for determining the state of a particle filter has an acoustic source for transmitting an acoustic signal toward the particle filter and an acoustic receiver for receiving the acoustic signal that has been changed by the particle filter. In addition, a control and evaluation unit is provided for evaluating the received acoustic signal.

The method according to the present invention for determining the state of a particle filter includes the following steps. An acoustic source sends an acoustic signal toward the particle filter. An acoustic receiver receives the acoustic signal that has been changed by the particle filter and an evaluation unit determines the state of the particle filter based on this received signal.

Other advantageous embodiments of the present invention ensue from the characteristics disclosed in the dependent claims.

The acoustic source of the device according to the present invention can be a motor, a whistle, or a speaker. If the engine of the motor vehicle is used as the acoustic source, then this reduces the number of components to be integrated into the exhaust train.

In another embodiment form of the present invention, the acoustic source is embodied so that the acoustic signal produced lies in the ultrasonic range. This makes it possible to improve the spatial resolution.

The acoustic receiver of the device according to the present invention is advantageously embodied as a microphone.

In a modification of the present invention, the acoustic source is disposed on one side of the particle filter and the acoustic receiver is disposed on the other side of the particle filter.

It is also possible for the acoustic source and the acoustic receiver to be disposed on one side of the particle filter. This makes it possible to evaluate the altered sound waves that are reflected by the particle filter.

The device according to the present invention can also be provided with an additional acoustic receiver so that one acoustic receiver is disposed on one side of the particle filter and the other acoustic receiver is disposed on the other side of the particle filter.

In another embodiment form of the device according to the present invention, the evaluation unit is designed so that it can evaluate the amplitudes and/or compare the phase positions of the two acoustic signals to each other.

A modification of the method according to the present invention includes evaluation of the phase and/or the amplitude of the received acoustic signal.

The acoustic source advantageously produces a sinusoidal or pulse-shaped acoustic signal.

It is also advantageous to determine the ambient temperature based on the acoustic signals sent and received. Knowledge of the ambient temperature and therefore of the exhaust temperature is helpful for controlling the regeneration of the particle filter.

### DRAWINGS

A number of exemplary embodiments of the present invention will be explained in greater detail below in conjunction with three figures.

FIG. 1 is a schematic, cross-sectional depiction of a first embodiment form of the present invention.

FIG. 2 shows the curve over time of a transmitted signal and the received signal.

FIG. 3 is a schematic, cross-sectional depiction of a second embodiment form of the present invention.

The present invention makes use of the effect that porous materials impede sound as a function of the material's structure. A loaded filter that has an additional amount of filtrate on the surface, for example, consequently has a different acoustic impedance than an unloaded filter. The measurement of the exhaust backpressure represents the borderline case for direct current impedance with an infinitesimal frequency.

Therefore, the permeability of the sound and possibly a change in the phase are initially determined as a function of the frequency for various DPF loads. During operation, the acoustic impedance is determined and compared to the previously established impedances. This determines the load state of the DPF. According to one regeneration strategy, a suitable regeneration procedure can be initiated, for example, when a certain fill state has been exceeded. The acoustic impedance can be determined in the vehicle in a number of ways.

### Description of the First Exemplary Embodiment

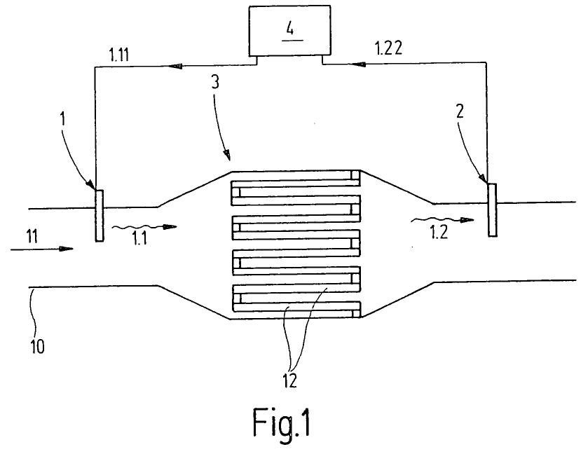

In the embodiment form of the present invention depicted in FIG. 1, an acoustic source 1, also referred to as acoustic generator, is disposed in an exhaust pipe 10 upstream of the DPF 3 in the flow direction 10 of the exhaust and an acoustic receiver 2 is disposed downstream of the DPF 3.

The acoustic source 1 produces a sound wave 1.1 that is then modified by the particle filter 3 and travels to the acoustic receiver 2, which receives it in the form of the modified sound wave 1.2. The received sound wave 1.2, which the acoustic receiver 2 has received and converted into an electrical signal 1.22, is then evaluated by an evaluation unit 4. The evaluation will be explained in greater detail further below.

The two elements comprising the acoustic source 1 and the acoustic receiver 2 can also be installed in the exhaust pipe 10 in the reverse order.

The acoustic source 1 can, for example, be a piezoelectric speaker or a whistle. The acoustic receiver 2 can, for example, be a microphone.

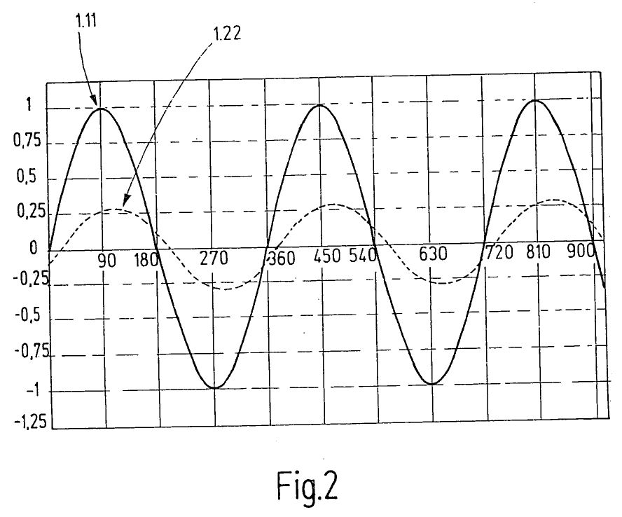

The sound wave 1.1 travels through the filter structure, which reduces its intensity and shifts its phase. FIG. 2 shows the corresponding signal curves. The amplitude is plotted on the y-axis and time is plotted on the x-axis.

Knowledge of the excitation signal 1.11 and of the incoming signal 1.22 makes it possible to determine both the phase shift and the intensity reduction.

For example, a sinusoidal signal can be used for the excitation signal 1.11, thus significantly facilitating the frequency-resolved evaluation. Other signal shapes are also possible and can be broken down into the frequency components by means of Fourier analysis. It is also possible to directly evaluate the signal transmission, for example of a short acoustic pulse. The choice of signal shapes and the measurement of the fundamental signal without an active acoustic generator 1 can be used to determine the background signal that is generated, for example, by the engine, so that it can be taken into account in the evaluation.

By evaluating the impedance at different frequencies, it is possible to get a picture of the spatial distribution of particle deposits in the DPF 3. It is therefore fundamentally possible to distinguish between deposits disposed at the upstream or downstream end of the DPF 3.

The achievable spatial distribution is determined essentially by means of the wavelength and frequency used. To achieve a local resolution on the order of magnitude of the particle filter, frequencies of greater than 500 Hz are used or better still, frequencies of greater than 2 kHz. If only the overall permeability of the particle filter 3 is of interest, is also possible to use lower frequencies.

For temporary pulses, a maximum pulse length therefore lies in the ms range.

The resolution can be significantly improved by using ultrasound.

In general, the radial distribution of particles over the parallel channels 12 of the particle filter 3 is homogeneous. More detailed information about a potential inhomogeneous distribution in the radial direction can be obtained through the use of several acoustic generators and/or acoustic receivers. This allows for a channel-by-channel analysis of the DPF load if necessary.

### Description of the Second Exemplary Embodiment

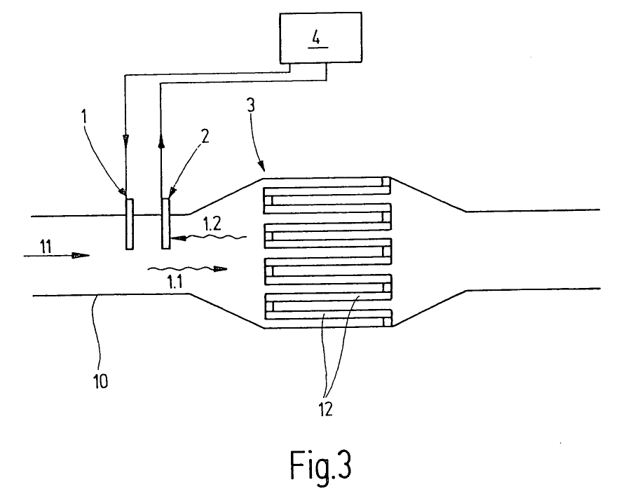

In lieu of the above-described placement of the acoustic source 1 and acoustic receiver 2 on two different sides of the DPF 3 for transmission of the sound, the placement of the acoustic source 1 and acoustic receiver 2 on one side of the DPF can also generate values for the reflection of the signal. FIG. 3 shows the corresponding placement. In it, the acoustic generator 1 and the acoustic receiver 2 are installed in the exhaust pipe 10 on the upstream side of the particle filter 3 in terms of the flow direction 11 of the exhaust. This placement in connection with pulsed signals corresponds to the operation of a sonar device.

The signal evaluation occurs in a fashion analogous to those in the above-described methods.

### Description of the Third Exemplary Embodiment

Instead of using a speaker or a whistle as the acoustic source 1, another embodiment form, not shown in the drawings, uses the acoustic emission of an already existing source, in particular that of the engine. In this case, two acoustic receivers are advantageously used, one of which is disposed upstream of the DPF and the other of which is disposed downstream of it. The correlation between the incoming and outgoing acoustic signal makes it possible to in turn determine the acoustic transmission. The Fourier analysis yields the frequency-resolved impedance, which is particularly advantageous for the evaluation of the load state.

If the engine noise is plotted in a time-resolved way and the values detected before and after the DPF are correlated with one another, then in addition to determining the damping, it is also possible to determine the signal travel time. The signal travel time can be analogously determined through pulse-like acoustic excitation with the aid of an acoustic generator and an acoustic receiver.

If the spatial positions of the two acoustic receivers are known, then this makes it possible to determine the speed of sound based on the signal travel time. The same is true if the spatial positions of the acoustic generator and the acoustic receiver are known. The speed of sound changes with the root of the absolute gas temperature, which is of interest, for example, for controlling the DPF regeneration. The shared use of the components according to the present invention makes it possible to eliminate a temperature sensor and test the functionality of other components, e.g. a preceding oxidizing converter provided to increase the temperature.

### Description of a Fourth Exemplary Embodiment

In another embodiment form not shown in the drawings, a sliding device moves an acoustic generator and/or an acoustic receiver into a succession of various positions so as to achieve a higher radial position resolution.

With the present invention, the internal state of the DPF is determined directly. The cross sensitivity to the volumetric flow that occurs during the differential pressure measurement is significantly reduced. The method and device permit inexpensive components to be used. The present invention can also be used to detect filter defects.

The acoustic components for testing the DPF state can also simultaneously perform other monitoring functions for the exhaust train. The recorded spectrum of engine noise as a function of the operating state can be used to detect a defect in the exhaust train, e.g. a leak, or a defect in the engine. This is useful as a backup diagnostic procedure.

1-12. (canceled)

13. A device for determining the state of a particle filter, comprising
an acoustic source (1) for transmitting an acoustic signal (1.1) toward the particle filter (3),
an acoustic receiver (2) for receiving the acoustic signal (1.2) that has been changed by the particle filter (3), and
an evaluation unit (4) connected to the acoustic receiver (2) for evaluating the received acoustic signal (1.2).

14. The device according to claim 13, wherein the acoustic source (1) is an engine, a whistle, or a speaker.

15. The device according to claim 13, wherein the acoustic source (1) is embodied so that the producible acoustic signal (1.1) lies in the ultrasonic range.

16. The device according to claim 14, wherein the acoustic source (1) is embodied so that the producible acoustic signal (1.1) lies in the ultrasonic range.

17. The device according to claim 13, wherein the acoustic receiver (2) is a microphone.

18. The device according to claim 14, wherein the acoustic receiver (2) is a microphone.

19. The device according to claim 15, wherein the acoustic receiver (2) is a microphone.

20. The device according to claim 13, wherein the acoustic source (1) is disposed on one side of the particle filter (3) and the acoustic receiver (2) is disposed on the other side of the particle filter (3).

21. The device according to claim 14, wherein the acoustic source (1) is disposed on one side of the particle filter (3) and the acoustic receiver (2) is disposed on the other side of the particle filter (3).

22. The device according to claim 15, wherein the acoustic source (1) is disposed on one side of the particle filter (3) and the acoustic receiver (2) is disposed on the other side of the particle filter (3).

23. The device according to claim 13, wherein the acoustic source (1) and the acoustic receiver (2) are disposed on the same side of the particle filter (3).

24. The device according to claim 14, wherein the acoustic source (1) and the acoustic receiver (2) are disposed on the same side of the particle filter (3).

25. The device according to claim 15, wherein the acoustic source (1) and the acoustic receiver (2) are disposed on the same side of the particle filter (3).

26. The device according to claim 20, wherein the acoustic source (1) and the acoustic receiver (2) are disposed on the same side of the particle filter (3).

27. The device according to claim 13, further comprising an additional acoustic receiver (2), with one acoustic receiver (2) being disposed on one side of the particle filter (3) and the other acoustic receiver being disposed on the other side of the particle filter (3).

28. The device according to claim 13, wherein the evaluation unit (4) is embodied so that it is able to evaluate the amplitude of the acoustic signal (1.2) and/or can compare the phase positions of the two acoustic signals (1.1, 1.2) to each other.

29. A method for determining the state of a particle filter, comprising the steps of
utilizing an acoustic source (1) to transmit an acoustic signal (1.1) toward the particle filter (3),
utilizing an acoustic receiver (2) to receive the acoustic signal (1.2) that has been transmitted to and changed by the particle filter (3), and
utilizing an evaluation unit (4) to determine the state of the particle filter (3) based on this received signal.

30. The method according to claim 29, further comprising the steps of evaluating the phase and/or the amplitude of the received acoustic signal (1.2).

31. The method according to claim 29, wherein the acoustic source (1) produces a sinusoidal or pulse-shaped acoustic signal.

32. The method according to claim 29, wherein the transmitted and received acoustic signals (1.1, 1.2) are used to determine the ambient temperature.
